(19) United States
(12) Patent Application Publication
(10) Pub. No.: US 2007/0229187 A1
(43) Pub. Date: Oct. 4, 2007

(54) HIGH-FREQUENCY CIRCUIT

(75) Inventor: Kazutaka TAKAGI, Kawasaki-City (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Kabushiki Kaisha Toshiba, Tokyo (JP)

(21) Appl. No.: 11/693,294

(22) Filed: Mar. 29, 2007

(30) Foreign Application Priority Data
Mar. 30, 2006 (JP) 2006-095513

(51) Int. Cl. H01P 5/12

(52) U.S. Cl. 333/125

(57) ABSTRACT

A high-frequency circuit is composed of a L-shape transmission path 11, a first branch line 12 and a second branch line 13 having a different line length from each other. A bent point A and a branch point B, from which the branch lines 12 and 13 are branched, are defined in the transmission line 11, and an adjustment conductor is connected between the points A and B.

### BACKGROUND OF THE INVENTION

1. Field of the Invention

The present invention relates to a high-frequency circuit, more specifically, to a high-frequency circuit to perform power dividing and power combining for a plurality of identical transistor cells used for a high-frequency semiconductor device in a microwave band.

2. Description of the Related Art

Currently, in a high-frequency circuit for a power amplifier to be used for satellite communication, etc., a plurality of identical transistor cells are arranged in parallel with one another, T-shape branch circuits respectively composed of micro strip lines are used in multi stages, then, power distributing or power combining is performed to each of transistor cells. FIG. 1 shows an example of such a high-frequency circuit. In a package 40 four semiconductor chips 41 are mounted and distributors 42 and combiners 43 each composing of a T-shape branch circuit are arranged in a tree shape on front and behind side of the chips 41. It has been known for such a power amplifier to enable suppressing phase differences among microwave signals propagating in each branch path of the T-shape branch circuits by providing a difference in length of two branch paths of the T-shape branch circuit (refer to Japanese Published Patent Application No. 2001-168656). Here, the reason for causing the phase differences among microwave signals propagating in each branch path of the T-shape branch circuits will be described with reference to FIG. 2. FIG. 2 is an enlarged schematic plane view illustrating a part of a structure of FIG. 1, in which parts corresponding to the elements shown in FIG. 1 are designated by corresponding reference numbers.

A high-frequency signal introduced from an input end of a first stage T-shape branch path 42-1 forming the distributor 42 on an input side is branched into two high-frequency signals. One of the signals is further branched into two by a second stage T-shape branch path 42-2 and then supplied to the semiconductor chips 41. In this case, if the high-frequency signals pass along a central part of each transmitting path forming the first and the second T-shape branch paths 42-1 and 42-2 respectively, as shown by arrows 44 with dotted lines in FIG. 2, no phase difference is caused between the high-frequency signals branched. However, the high-frequency signals actually pass along the shortest path formed in each branch path, as shown in FIG. 2 by arrows 45 with full lines. Therefore, the phase difference occurs between the signals branched in accordance with the difference in the traveling distances of the signals branched. Such a phenomenon goes same in the combiner 43. That is, output signals amplified by the semiconductor chips 41 are introduced into each branch path of the first T-shape branch path 43-1 forming the combiner 43, then, supplied to one of the branch paths of the second T-shape branch path 43-2. Tow high-frequency signals inputted pass along the shortest path in the branch paths and are combined at a combining point 46 in the second T-shape branch path 43-2, as indicated by the full lines 45. Between the two high-frequency signals to be combined, there is a difference in path lengths along which each of the signals passes. Thus, there occurs a phase difference between the signals. Accordingly, two high-frequency signals cancel with each other and amplitude of a combined signal is decreased compared to the amplitude where two high-frequency signals having no phase difference are combined. In other words, such a phenomenon decreases a gain of the amplified high-frequency signal.

The phase difference may be canceled by providing a difference in lengths of the two branch paths of the T-shape branch circuit to suppress such phase differences. In such a method, however, it is difficult to accurately set the difference between the lengths of two branch paths in manufacturing the circuit. That is, according to the method, the phase difference varies greatly according to the small difference between the lengths of the two branch paths. Thus, there is a need to require high precision in patterning micro strip lines forming the T-shape branch circuit.

In the method using the difference in lengths of the two branch paths, an optimum value of the difference varies depending on the frequency used. Thus, it is impossible to share circuit components among different circuits using different frequencies and thus it is necessary to redesign every circuit using a different frequency for manufacturing.

Accordingly, taking the technical issues described above, it is one of the objects of the present invention to provide a high-frequency circuit in which an easy adjustment is provided for preventing a reduction in gain of an amplified signal at a combined point due to the phase differences among the microwaves signals propagating in each branch path of the T-shape branch circuit.

It is another object of the present invention to provide a printed circuit board, which can be shared among high-frequency circuits using frequencies in a certain range (within ±5%).

### SUMMARY OF THE INVENTION

According to an embodiment of the present invention for solving the technical problems described above, there is provided a high-frequency circuit, including an L-shape transmission path having a first transmission line and a second transmission line which form a shape of a letter ‘L’, first and second branch lines having line lengths different from each other, the branch lines being connected in substantially orthogonal fashion to an end of the second transmission line, and being extended in opposite directions to each other, and an adjusting conductor added to the second transmission line so as to broaden a line width between a bent point of the L-shape transmission path and a branch point where the first and second branch lines are branched.

Further, according to another embodiment of the invention, there is provided a high-frequency circuit, including a two-stage connection T-shape branch circuit including a first T-shape branch path having a first horizontal part and a first vertical part perpendicular to the first horizontal part, and a second T-shape branch path having a second horizontal part and a second vertical part perpendicular to the second horizontal part, wherein an end of the second vertical part of the second T-shape branch path is connected to an end part of the first horizontal part of the first T-shape branch path, and a width of the second vertical part of the second T-shape branch path is narrower than a width of the second horizontal part, and wherein an adjustment conductor is added so as to broaden a width between the other end of the second vertical part and a bent point of a letter ‘L’ shape formed by the second vertical part and the first horizontal part.

Further, according to yet other embodiment of the invention, there is provided a high-frequency circuit, including a distributor configured to distribute a high-frequency signal into a plurality of distributed high-frequency signals, a plurality of semiconductor amplifiers configured to amplify the plurality of distributed high-frequency signals, and a combiner configured to combine the amplified high-frequency signals, and wherein the distributor is included in a two-stage connection T-shape circuit having a first T-shape branch path and a second T-shape branch path, the first T-shape branch path having a first horizontal part and a first vertical part, the second T-shape branch path having a second horizontal part and a second vertical part, an end of the first horizontal part being connected to an end part of the first horizontal part, a width of the second vertical part being narrower than a width of the second horizontal part, and wherein an adjustment conductor is added so as to broaden a width between the other end of the second vertical part and a bent point of a letter ‘L’ shape formed by the second vertical part and the first horizontal part.

### BRIEF DESCRIPTION OF THE DRAWINGS

FIG. 1 is a plane view showing an example of a conventional high-frequency power amplifier circuit;

FIG. 2 is a partially enlarged plane view for explaining operations of the power amplifier circuit in FIG. 1;

FIG. 3 is a partially enlarged plane view showing a line pattern of a T-shape distributor according to an embodiment of the present invention;

FIG. 4 is a graph showing a relation obtained by results of measurements between shift amounts of a line pattern and gain reductions at a combined point in a circuit pattern shown in FIG. 3;

FIG. 5 is a graph showing a relation obtained by results of measurements between widths of an adjusting conductor to be added and gains at a combined point in a circuit pattern shown in FIG. 3; and

FIG. 6 is a graph showing a relation obtained by results of measurements between widths of an adjusting conductor to be added and gains at a combined point in a circuit pattern shown in FIG. 3.

### DETAILED DESCRIPTION OF THE INVENTION

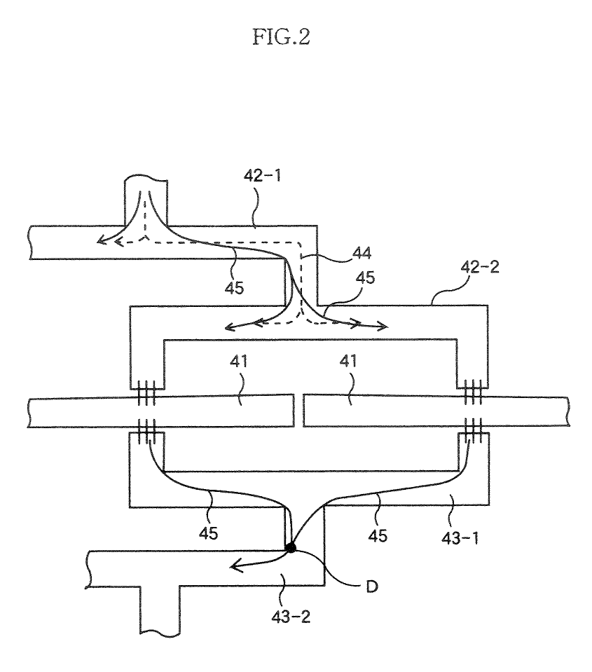

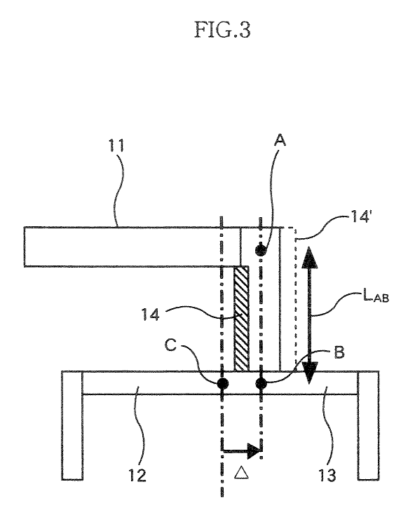

Hereinafter, embodiments of the present invention will be described in detail. FIG. 3 illustrates a circuit pattern of a part of a two-stage T-shape Wilkinson distributor or combiner according to an embodiment of the invention. The circuit pattern is composed of an L-shape transmission path 11, a first branch line 12, a second branch line 13 having a different length from the first branch line 12. The L-shape transmission line 11 is composed of a first horizontal transmission line 11-1 and a first vertical transmission line 11-2 which form a shape of a letter ‘L’. In the L-shape transmission path 11, a bent point A and a branch point B are defined. The first branch line 12 and the second branch line 13 is branched at the branch point B. Then, a distance between the points A and B is defined as L_{AB}. Here, the first horizontal transmission line 11-1 corresponds to the horizontal part of a first branch path 42-1 shown in FIG. 2. Further, the first vertical transmission line 11-2 of the L-shape transmission path 11, the first branch line 12 and the second branch line 13 form a second T-shape branch path corresponding to a second T-shape branch path 42-2 shown in FIG. 2. That is, the T-shape branch path shown in FIG. 3 shows a part of a two-stage connected T-shape branch path in which one end of a vertical part of the second T-shape branch path is connected to one end of a horizontal part of the first T-shape branch path.

The two-stage connection T-shape branch path is, for example, formed as a micro strip line on an aluminum substrate. The aluminum substrate has relative permittivity of 9.8. If it is intended to produce a conventional Wilkinson distributor or a combiner by using an aluminum substrate with 0.25 mm thickness, the line width of the transmission line 11 becomes around 0.25 mm, and the line width of the first branch line 12 and the second branch line 13 become around 0.125 mm respectively.

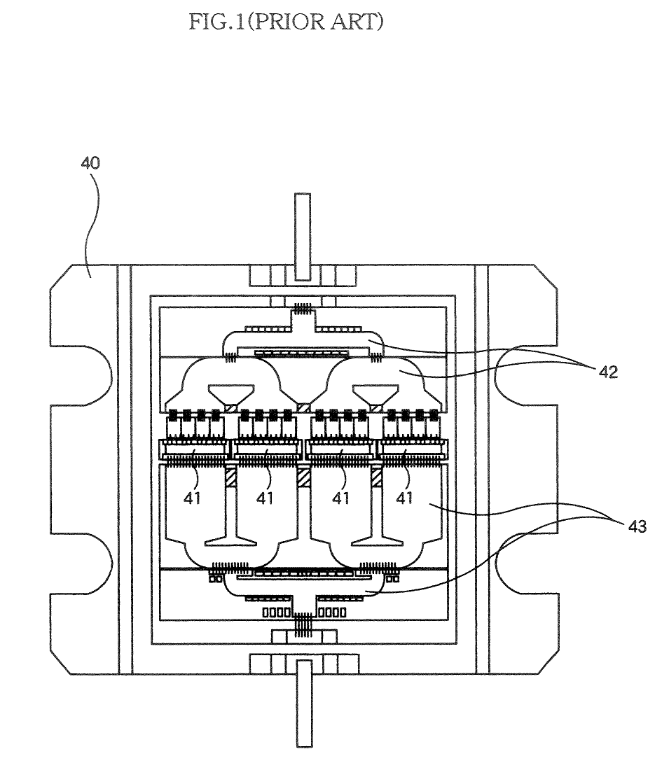

In a micro strip circuit shown in FIG. 1 in which the T-shape Wilkinson type distributor circuit and a combiner circuit are arranged on both sides of a power semiconductor element connected with each other, microwave signals do not propagate along a center portion of a width of the strip line between the bent point A and the branch point B of the transmission line 11, but they propagates along the shortest paths in the L-shape transmission path 11. Therefore, a path length of the microwave signals propagating through the first branch line 12 and a path length of the microwave signals propagating through the second branch line 13 are made equal to each other by shifting the branch point B by Δ away from a point C, which is a central point of a branch line composed of the first branch line 12 and the second branch line 13. As a result, it becomes possible to make the transmission times of the microwave signals propagating through the first branch line 12 and the second branch line 13 are made equal to each other and no phase difference occurs between microwave signals propagating through the branch lines.

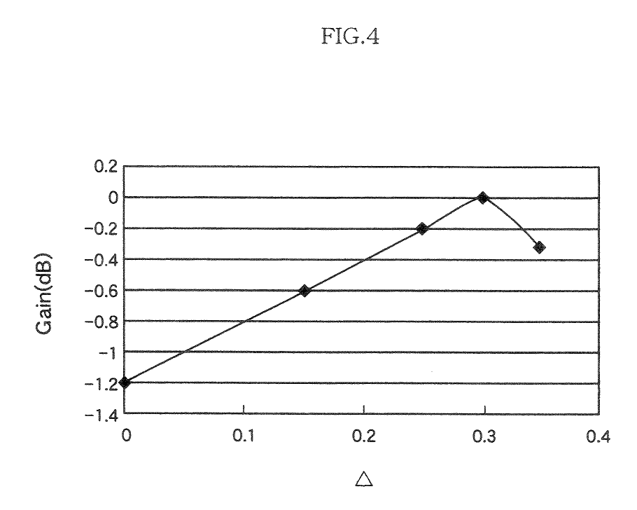

FIG. 4 shows results of measurements of a gain at a combined pint D in the second T-shape branch path shown in FIG. 2 by varying the shifting amount Δ described above. FIG. 4 shows that the optimum value of the shifting amount Δ is 0.3 mm in the embodiment of the present invention. FIG. 4 clearly shows that the gain at the combined point D increases up to a peak when the shifting amount Δ is close to the optimum value 0.3 mm. However, FIG. 4 also shows that the gain decreases rapidly even when the shifting amount Δ is slight. That is, the sensitivity of the gain is too high against the shifting of the position of the branch point B. Thus, the problem arises that even a slight positional error in manufacturing of the strip line will bring about a great decrease in the gain from the peak value.

According to an embodiment of the invention, therefore, the L-shape transmission path 11 is so designed that the line width at a portion between the bent point A and the branch point B is made narrower by 20% than the line width of the rest of the L-shape transmission path 11. As shown in FIG. 3, the line width is broadened by adding an adjusting conductor (metal) with confirming the shifting direction of the pattern. Among some of the methods for adding the adjusting metal to increase the line width, pasting gold foil or bonding a plurality of wires are actual approaches. If it is acceptable to sacrifice a degree of precision for manufacturing, applying of conductive adhering with sintering thereafter is another alternative. The adhering of the gold foil may be made by being pressed and applying ultrasonic waves while it is heated. The gold foil forming the adjustment conductor desirably has substantially the same width as that of a vertical part of the L-shaped transmission line, because the adjustment of the line width is easy.

With thinning of the line width by about 20%, characteristic impedance of the line may increase. However the increase may be limited within a range of around 10% or less.

In addition, it is possible to restore the characteristic impedance of the line to a value designed after adjusting the line width with the adjusting conductor 14.

Concerning the line length LAB between the bent point A and the branch point B, it is possible to prevent the phase difference from occurring by selecting it to 1/16 of the wavelength λ or shorter and longer than the thickness of the substrate. The shorter the line length LAB is set, the less the phase difference may be. However, the first horizontal transmission line 11-1 of the L-shape transmission path 11 may be close to contact the first branch line 12 and the second branch line 13. If the first horizontal transmission line 11-1 of the L-shape transmission path 11 gets close to the first branch line 12 even if they do not contact with one another, the characteristic impedance of each of them is varied by interference between them. In the case of the micro strip line, a high-frequency ground level is provided under the substrate. The high-frequency ground level and the micro strip line decide the characteristic impedance of the micro strip line on the substrate. Thus, the change in the characteristic impedance is avoided if two lines are formed at portions apart from each other by the distance more than the thickness of the substrate.

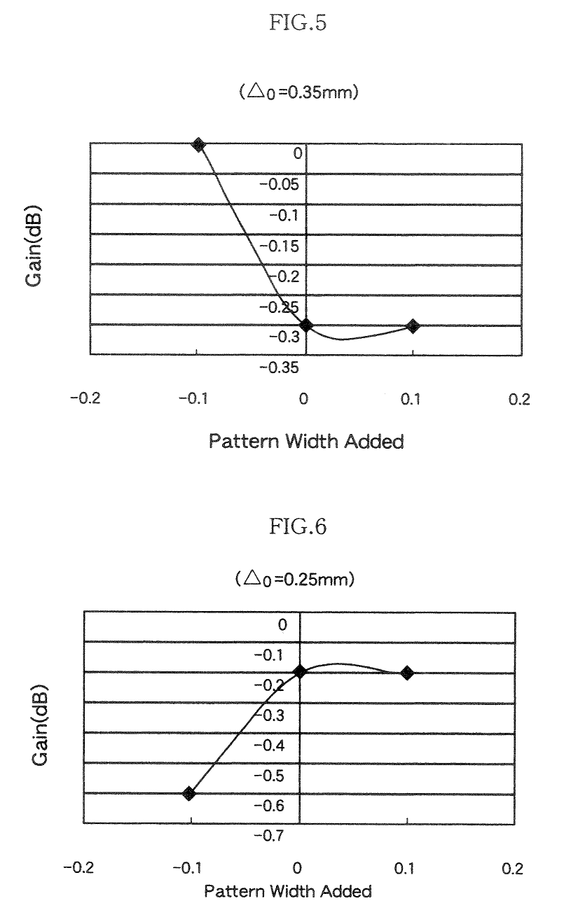

FIG. 5 and FIG. 6 are views respectively illustrate results obtained by measuring how the gain reduction at the combined point varies depending on the pattern width added to the initial shifting amount. FIG. 5 shows the case where the initial shifting amount is 0.35 mm. FIG. 6 shows the case where the initial shifting amount is 0.25 mm. That is, in FIG. 5, the shifting amount is selected as 0.35 mm at the beginning by reducing the optimum shifting amount 0.3 mm by 0.05 mm. In such a state, the conductor pattern 14 is added to the portion of the L-shape transmission path 11 between the bent point A and the branch pint B at the inside (left side) or outside (right side) portion of the L-shape transmission path 11 to increase the line width. In FIG. 5, the right side of the figure indicates the change in the gain at the combined point D when a conductor pattern 14′ is added to the outside of the L-shape transmission path 11, as shown with a dotted line in FIG. 3. In FIG. 5, the left side of the figure indicates the change in the gain at the combined point D when the conductor patter 14 is added to the inside of the L-shape transmission path 11. As it is clear from FIG. 5, the conductor pattern 14 added to outside of the L-shape transmission path 11 does not improve the reduction in the gain. However, the conductor pattern 14 added to inside of the L-shape transmission path 11 improves the reduction in the gain and can avoid any reduction in the gain by adding the conductor pattern 14 having a line width of 0.1 mm.

In contrast, the shifting amount is selected as 0.25 mm at the beginning by reducing the optimum shifting amount 0.3 mm by 0.05 mm. The right side of FIG. 6 indicates the change in the gain at the combined point D when the conductor pattern 14 is added to outside the L-shape transmission path 11, as is the case with FIG. 5. The left side of FIG. 6 indicates the change in the gain at the combing point D when the conductor pattern 14′ is added outside the L-shape transmission path 11. In this case, it is clear from FIG. 6 that adding the conductor pattern 14 or 14′ to any side of the L-shape transmission path 11 does not improve the reduction in gain.

The experiment described above has shown that it is effective to set the shifting amount to be more than the optimum amount from the beginning and to add the conductor pattern 14 to the inside of the L-shape transmission path 11 to broaden the line width, as shown in FIG. 5. Thus, according to the embodiment of the invention, the shifting amount is selected to be more than the optimum shifting amount and the conductor pattern 14 is added to the inside of the L-shape transmission path 11.

As mentioned above, in the high-frequency circuit according to the embodiment of the present invention, the T-shape Wilkinson distributor or combiner includes the L-shape transmission path and two branch lines connected to the L-shape transmission path, wherein the line length between the bent point in the L-shape transmission path and the branch point of the two branch lines is selected to be equal to 1/16 of the wavelength λ or shorter and is longer than the thickness of the substrate. Thus, there is no need to adjust the characteristic impedance of the transmission line. The line width of the L-shape transmission path between the bent point and the branch point of the branch lines is selected to be thinner than the line width providing optimum impedance, so that the adjustment of the characteristic impedance may be conducted with ease. Further, the adjustment of the characteristic impedance may be conducted with ease even in the case where the difference in the line length is shifted from optimum phase condition.

It is our intension that the present invention is not limited to the specific details and representative embodiments shown and described herein, and in an implementation phase, this invention may be embodied in various forms without departing from the spirit or scope of the general inventive concept thereof.

What is claimed is:

1. A high-frequency circuit, comprising:
an L-shape transmission path having a first transmission line and a second transmission line which form a shape of a letter ‘L’;
first and second branch lines having line lengths different from each other, the branch lines being connected in substantially orthogonal fashion to an end of the second transmission line, and being extended in opposite directions to each other; and
an adjusting conductor added to the second transmission line so as to broaden a line width between a bent point of the L-shape transmission path and a branch point where the first and second branch lines are branched.

2. The high-frequency circuit according to claim 1, wherein the second transmission line is thinner than other the first transmission line.

3. The high-frequency circuit according to claim 1, wherein the adjustment conductor is a gold foil or a gold wire.

4. The high-frequency circuit according to claim 3, wherein the gold foil has substantially the same width as that of the second transmission line.

5. The high-frequency circuit according to claim 1, wherein the L-shape transmission path is a part of a two-stage connection T-shape branch circuit including first and second T-shape branch paths connected in a tree shape, and each of the first and second T-shape branch paths including a horizontal part and a vertical part perpendicular to the horizontal part.

6. The high-frequency circuit according to claim 1, wherein a length between a bent point of the L-shape transmission path and a branch point where the first and second branch lines are branched is selected as to be equal to or shorter than 1/16 of a use signal wavelength λ, and to be longer than a thickness of a substrate where the L-shape transmission path is provided.

7. A high-frequency circuit, comprising:
a two-stage connection T-shape branch circuit including a first T-shape branch path having a first horizontal part and a first vertical part perpendicular to the first horizontal part, and a second T-shape branch path having a second horizontal part and a second vertical part perpendicular to the second horizontal part,
wherein an end of the second vertical part of the second T-shape branch path is connected to an end part of the first horizontal part of the first T-shape branch path, and a width of the second vertical part of the second T-shape branch path is narrower than a width of the second horizontal part, and
wherein an adjustment conductor is added so as to broaden a width between the other end of the second vertical part and a bent point of a letter ‘L’ shape formed by the second vertical part and the first horizontal part.

8. A high-frequency circuit, comprising;
a distributor configured to distribute a high-frequency signal into a plurality of distributed high-frequency signals;
a plurality of semiconductor amplifiers configured to amplify the plurality of distributed high-frequency signals; and
a combiner configured to combine the amplified high-frequency signals;
and wherein the distributor is included in a two-stage connection T-shape circuit having a first T-shape branch path and a second T-shape branch path, the first T-shape branch path having a first horizontal part and a first vertical part, the second T-shape branch path having a second horizontal part and a second vertical part, an end of the first horizontal part being connected to an end part of the first horizontal part, a width of the second vertical part being narrower than a width of the second horizontal part,
and wherein an adjustment conductor is added so as to broaden a width between the other end of the second vertical part and a bent point of a letter ‘L’ shape formed by the second vertical part and the first horizontal part.

9. A high-frequency circuit, comprising;
a distributor configured to distribute a high-frequency signal into a plurality of distributed high-frequency signals;
a plurality of semiconductor amplifiers configured to amplify the plurality of distributed high-frequency signals; and
a combiner configured to combine the amplified high-frequency signals;
and wherein the combiner is included in a two-stage connection T-shape circuit having a first T-shape branch path and a second T-shape branch path, the first T-shape branch path having a first horizontal part and a first vertical part, the second T-shape branch path having a second horizontal part and a second vertical part, an end of the first horizontal part being connected to an end part of the first horizontal part, a width of the second vertical part being narrower than a width of the second horizontal part,
and wherein an adjustment conductor is added so as to broaden a width between the other end of the second vertical part and a bent point of a letter ‘L’ shape formed by the second vertical part and the first horizontal part.
